(19) United States
(12) Patent Application Publication
(10) Pub. No.: US 2025/0270469 A1
(43) Pub. Date: Aug. 28, 2025

(54) PROCESS AND SYSTEM FOR EXTRACTING DISTILLER VEGETABLE OIL FROM WHOLE STILLAGE

(71) Applicant: Arch Grain Technologies, Inc., St. Louis, MO (US)

(72) Inventor: Eric Hakmiller, St. Louis, MO (US)

(73) Assignee: Arch Grain Technologies, Inc., St. Louis, MO (US)

(21) Appl. No.: 19/039,965

(22) Filed: Jan. 29, 2025

Related U.S. Application Data
(60) Provisional application No. 63/559,004, filed on Feb. 28, 2024.

(51) Int. Cl. C11B 1/06

(52) U.S. Cl. CPC C11B 1/06

(57) ABSTRACT

A system and process for recovering oil from whole stillage wherein whole stillage is introduced a mechanical separation device, such as a screw press, a stack disc centrifuge, or a three phase centrifuge. The separation device separates the whole stillage into a first light fraction and a first heavy fraction. The first heavy fraction is transferred to a secondary whole stillage tank and the first light fraction is transferred to a first decanter. The first decanter separates the first light fraction into a second light fraction and a second heavy fraction. The second heavy fraction is transferred to the secondary whole stillage tank with the first heavy fraction and the second light fraction undergoes one or more additional separation before being combined with the oil-rich thin stillage stream and transferred downstream to undergo oil recovery.

### FIELD OF INVENTION

The present invention relates to a process and system for separating fiber and oil from whole stillage and recovering increased amounts of oil.

### BACKGROUND

Typical ethanol dry mill processes begin with grinding a feedstock into flour with a hammer mill then wetting the flour to create a mash. Feedstocks may include corn, barley, sorghum, or any suitable vegetable or grain. The mash may be further ground in a fine grinding operation or it may be transferred directly to a liquefaction tank where enzymes are added to convert the starches in the mash to sugars. These sugars are thereafter converted into ethanol through fermentation. Following fermentation, the entire mix from the fermentation vessel is delivered to a distillation process where it is further heated. The primary product (ethanol) is thereafter captured by distillation. Other process steps may also be employed to help dry the crude ethanol. The process mix remaining after removing ethanol is generally referred to as whole stillage.

Whole stillage contains all the unfermentable fractions of the feedstock. Whole stillage includes fibers, proteins, water, and oil remnants of the feedstock mash after removing sugars in the fermentation step referenced above. Whole stillage can be separated into many valuable coproducts such as oils, referred to as distillers corn oil (DCO), syrup, high proteins distillers dry grain, or wet distillers dry grain with solubles (DDGS) depending on the unit of operations applied to the whole stillage. As used herein, the term “distillers corn oil” (DCO) is intended to include the oil of any vegetable feedstock and not be limited to oil from corn.

Decanter centrifuges have traditionally been used to separate the heavier solids from the lighter liquids in the whole stillage. Centrifugal separation of whole stillage creates a solids (heavy) fraction known as cake and liquid (light) fraction that is known as thin stillage. The thin stillage stream usually is thickened through evaporation and then centrifuged again to yield DCO. The cake generally is sent to some form of drying to yield DDG and often the defatted syrup from the thin stillage line is added to create dry distillers grain with solubles (DDGS). The cake before drying, contains roughly 65% liquid or moisture. The liquid/moisture component of the cake contains a percentage of oil that is similar to the percentage of oil in the thin stillage fraction. Thus, a significant portion of oil ends up in the DDGS. This has traditionally been acceptable to the industry because the fraction extracted from the thin stillage adds sufficient value and the methods to extract oil from the cake are very difficult. However, it would be desirable for many ethanol processing operations to recover more oil in the DCO stream instead of having the oil in the cake end up in the DDGS stream. Therefore, there is a need for an improved process and system for removing oil directly from the whole stillage, thereby increasing oil recovery and enhancing the profitability of the ethanol production process.

### BRIEF SUMMARY

One aspect of the present invention relates to a process for recovering oil from whole stillage. The process comprises introducing whole stillage to a mechanical separation device, such as a screw press, a filter press, a tricanter, a stack disc centrifuge, or a three phase centrifuge. The separation device separates the whole stillage into a first light (liquid) fraction and a first heavy (fiber) fraction. The separation device uses mechanical pressure, filtration, or centrifuge principles to separate the solid material from the liquid components of the whole stillage. The first heavy fraction is directed or transferred to a secondary whole stillage tank and the first light fraction is directed to an oil separation system. One possible system is a first decanter tank.

The first decanter allows the oil rich light fraction to rise toward the top and any solids/heavy fractions to sink toward the bottom of the tank. The first decanter separates the first light fraction into a second light fraction and a second heavy fraction. The second heavy fraction is transferred to the secondary whole stillage tank with the first heavy fraction and the second light fraction undergoes further separation and/or is transferred downstream to undergo DCO recovery.

In some embodiments the second light fraction is directed to a second decanter tank where a similar separation occurs resulting in a third light fraction and a third heavy fraction. The third heavy fraction is transferred to the secondary whole stillage tank with the first and second heavy fractions and the third light fraction undergoes further separation and/or is transferred downstream to undergo DCO recovery.

In some embodiments the third light fraction is directed to a third decanter where a similar separation occurs resulting in a fourth light fraction and a fourth heavy fraction. The fourth heavy fraction is directed to the secondary whole stillage tank with the first, second, and third heavy fractions and the fourth light fraction undergoes further separation and/or is directed downstream to undergo DCO recovery.

Each heavy fraction contains fiber, protein, water, oil, and residual sugars. Each light fraction contains fiber, protein, water, oil, and residual sugars. Each successive separation results in a light fraction containing a higher percentage of oil and lower percentage of fiber and a heavy fraction containing a lower percentage of oil and higher percentage of fiber. In other words, after each separation the liquid stream becomes more oil-rich. The heavy fraction(s) in the secondary whole stillage tank is/are directed to a mechanical separator such as a decanter centrifuge to separate the thin stillage from the cake. The thin stillage is directed to the DCO hold tank where it is mixed with one or more of the light fractions recovered from the decanters. Together, the material in the DCO holding tank comprises a crude DCO. From the DCO holding tank the oil-rich stream undergoes another separation, which may be by centrifuge, to separate the purified DCO from the defatted syrup resulting in the recovery of the high value purified DCO coproduct.

Another aspect of the present invention relates to a process for recovering oil from whole stillage. This aspect is similar to the one described above except a three phase centrifuge is used as the mechanical separator. Further, a plate separator is used instead of a second decanter and a caustic refining tank is used instead of the third decanter. The plate separator helps increase the globular size of each oil droplet, which helps improve downstream centrifugation. The oil has been through several separations by the time it reaches the caustic refining tank. The water/oil emulsion uses residual protein to hold these two materials together. The caustic refining tank helps free the oil from the water by increasing pH to between about 6.5-6.9 so the protein drops out of solution as it is at its iso-electric point. Changing the pH of fibrous material is more difficult than changing the pH of liquid materials. Thus, it is beneficial to have the stream contain as little fiber as possible when it enters the caustic refining tank. It should be noted that the plate separator and the caustic refining tank could be used with the first embodiment described above, if desired.

Another aspect of the present invention relates to a process for recovering oil from whole stillage. This aspect is similar to the ones described above except an additional centrifuge separates the oil-rich stream into yet another light fraction and heavy fraction before the oil-rich stream is transferred to the DCO hold tank.

Another aspect of the present invention relates to a system for recovering oil from whole stillage. The system comprises whole stillage tanks, decanter tanks, a separate tank for oil decanting, a plate separator, a caustic separator, and a secondary whole stillage tank. In addition, the system includes pumps and pipes to convey the various liquid and solid streams between system components.

Another aspect of the present invention relates to a process for recovering oil from whole stillage. This aspect is similar to the one described above except a screw press is used as the mechanical separator. The heavy fraction is directed to the secondary whole stillage tank as described above. The light fraction, however, is sent to another mechanical separator, such as a centrifuge, for oil separation. In one embodiment of this the liquids sent to a stack disc centrifuge. The remaining solids after the centrifuge are returned to the secondary whole stillage tank while the lighter oil-rich fraction is directed to the DCO holding tank located after the evaporation unit.

In another embodiment of this invention the lighter phase is sent to a decanter centrifuge where the solids are returned to the secondary whole stillage tank and the lighter oil rich fraction is sent directly to the corn oil holding tank located after the evaporators.

Another aspect of the present invention relates to a process for recovering oil from whole stillage. This aspect is similar to those described above. In this embodiment the first light/liquid fraction is sent to a three phase or disc nozzle centrifuge. In this embodiment the heavier solids fraction from the centrifuge are sent back to the secondary whole stillage tank. The lighter oil rich fraction is sent to the DCO holding tank located after the evaporation. The third water phase is sent to a plate separator which concentrated the very fine globules of oil. This oil is sent to the DCO holding tank after the evaporators. The water fraction out of the plate separators is returned to the secondary whole stillage tank.

### BRIEF DESCRIPTION OF THE DRAWINGS

The disclosure will be better understood, and features, aspects, and advantages other than those set forth above will become apparent when consideration is given to the following detailed description thereof. Such detailed description refers to the following drawings.

FIG. 1 is a process flow diagram showing a traditional ethanol plant.

FIG. 2 is a process flow diagram of an embodiment of the invention.

FIG. 3 is a process flow diagram of another embodiment of the invention.

FIG. 4 is a process flow diagram of yet another embodiment of the invention.

FIG. 5 is a process flow diagram of yet another embodiment of the invention.

FIG. 6 is a process flow diagram of yet another embodiment of the invention.

### DETAILED DESCRIPTION

The apparatus, devices, systems, products, processes, and methods of the present invention will now be described in detail by reference to various non-limiting embodiments, including the figures which are exemplary only. For the purposes of promoting an understanding of the principles of the disclosure, reference will now be made to embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

As used in the specification, articles “a” and “an” refer to one or to more than one (i.e., at least one) of the grammatical object of the article. By way of example, “an element” means at least one element and can include more than one element.

“About” is used to provide flexibility to a numerical range endpoint by providing that a given value can be “slightly above” or “slightly below” the endpoint without affecting the desired result. The term “about” in association with a numerical value means that the numerical value can vary by plus or minus 5% or less of the numerical value.

Throughout this specification, unless the context requires otherwise, the word “comprise” and “include” and variations thereof (e.g., “comprises,” “comprising,” “includes,” “including”) will be understood to imply the inclusion of a stated component, feature, element, or step or group of components, features, elements, or steps but not the exclusion of any other integer or step or group of integers or steps.

As used herein, “and/or” refers to and encompasses any and all possible combinations of one or more of the associated listed items, as well as the lack of combinations were interpreted in the alternative (“or”).

Recitation of ranges of values herein are merely intended to serve as a succinct process of referring individually to each separate value falling within the range, unless otherwise indicated herein. Furthermore, each separate value is incorporated into the specification as if it were individually recited herein. For example, if a range is stated as 1 to 50, it is intended that values such as 2 to 4, 10 to 30, or 1 to 3, etc., are expressly enumerated in this disclosure. These are only examples of what is specifically intended, and all possible combinations of numerical values between and including the lowest value and the highest value enumerated are to be considered to be expressly stated in this disclosure.

Throughout the specification and claims, terms like “directing” or “introducing” certain product or process streams to other processes or components does not require a direct path. For example, a certain product described or claimed as being directed to the DCO hold tank 104 may pass through other components or be subject to other process steps before reaching the DCO hold tank 14.

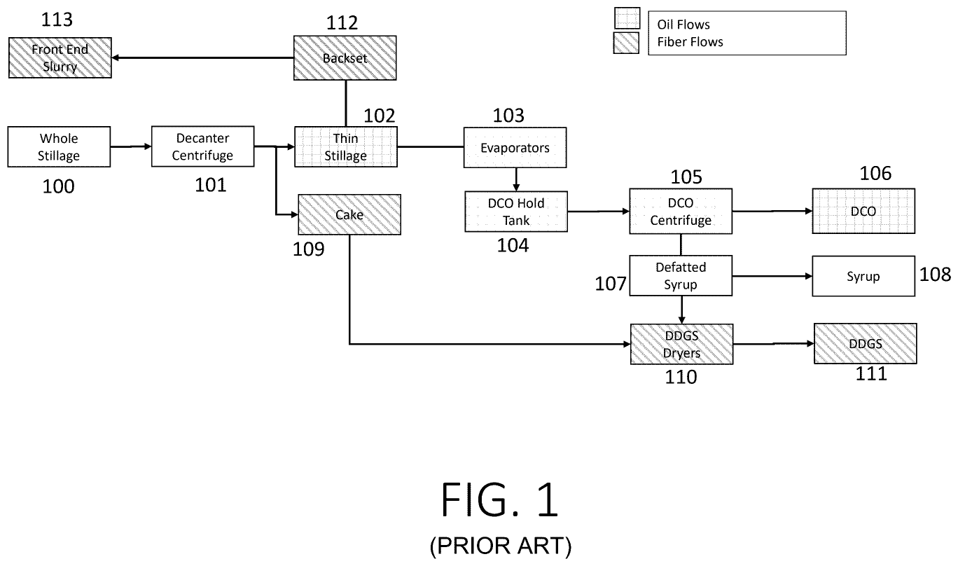

FIG. 1 shows an exemplary traditional process for separating valuable coproducts from whole stillage. FIG. 1 and its accompanying description are provided herein to help illustrate the differences and improvements embodied in the present invention. Whole stillage 100 obtained from the ethanol production process is stored in dedicated whole stillage tanks 100 after distillation removes the ethanol. (As used herein, the particular product and the tank/stream holding/transferring the product sometimes have the same reference number). The whole stillage 100 may be taken directly from (and be part of) an ethanol or beer production process, or the whole stillage 100 may be delivered to and processed at a facility remote from the alcohol production facility. As shown in FIG. 1, the whole stillage 100 is introduced to a decanter centrifuge 101 or settling tank which separates the stream into thin stillage 102 as the light fraction and cake 109 as the solid/heavy fraction. The thin stillage 102 is further separated into the backset 112 and the light oily fraction is moved to the evaporators 103 to remove water and thicken the thin stillage 102. From the evaporators 103, the oil-rich stream moves to the distillers corn oil (DCO) hold tank 104 before moving to the DCO centrifuge 105. The DCO centrifuge 105 separates the stream into recovered DCO 106 and defatted syrup 107. The defatted syrup 107 is further processed to syrup 108 and a fraction that moves to the DDGS dryers 110. The backset 112 from the thin stillage 102 is further processed to a front-end slurry 113 which can be recycled upstream into the ethanol production process. The cake 109 resulting from separation from the decanter centrifuge 101 is then transferred to the DDGS dryers 110 with the defatted syrup 107 to yield DDGS 111.

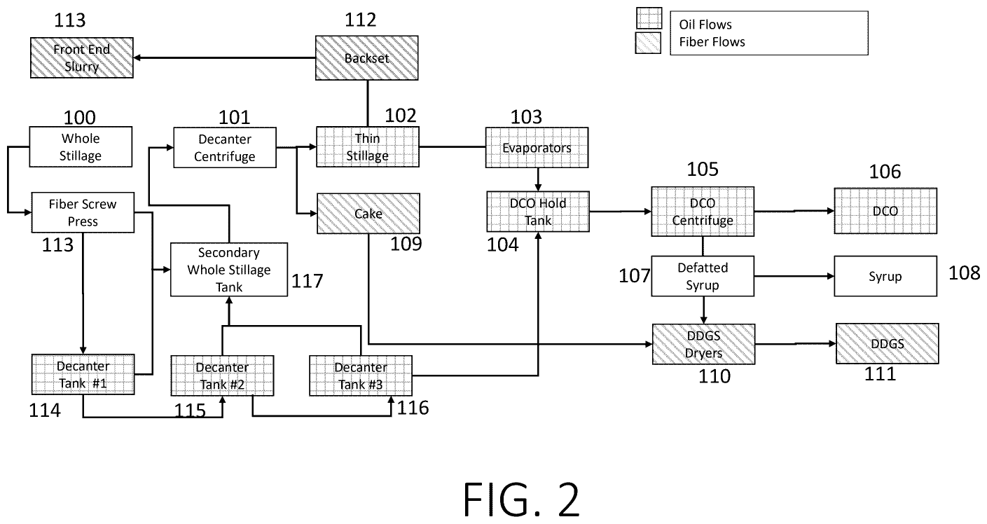

FIG. 2 shows one embodiment of the invention for recovering oil from whole stillage 100 100. The process comprises introducing whole stillage 100 to a mechanical separator such as a screw press 113 to separate the whole stillage 100 into a first light fraction and a first heavy fraction. The screw press 113 uses mechanical pressure and filtration principles to separate the fiber from the liquid components of the whole stillage 100. In some embodiments the screw press 113 consists of a cylindrical chamber with an internal screw conveyor that moves the whole stillage fiber mixture along its length over a fine screen. As the whole stillage fiber mixture progresses through the screw press, mechanical pressure is applied by the rotating screw conveyor, compressing the fiber and forcing the liquid component to pass through the perforated screen walls of the screw press chamber. The size of the screen will determine how much separation occurs in the chamber. This separation process effectively separates the liquid from the fiber.

The first heavy fraction is transferred to a secondary whole stillage tank 117 and the first light fraction is transferred to a first decanter 114. The first decanter 114 separates the first light fraction into a second liquid (light) fraction having a higher concentration of oil than the first light fraction and a second fiber (heavy) fraction comprising fiber/solids and having a lower concentration of oil than the first heavy fraction. In one embodiment the first light fraction has a residence time of between about six to eight hours in the first decanter tank 114. The lighter light fraction rises to the top of the tank 114, while the heavier solids fractions will settle to the bottom of the tank 114. The ratio of amounts being pulled from the top and bottom of the tank 114 can be adjusted to maximize oil separation as long as they are equal to the amount that is entering the tank. The second heavy fraction is transferred to the secondary whole stillage tank 117 with the first heavy fraction and the second light fraction undergoes further separation and/or is transferred downstream to undergo DCO recovery.

In the embodiment shown in FIG. 2, the second light fraction is transferred to a second decanter 115 where a similar separation occurs resulting in a third liquid (light) fraction having a higher concentration of oil and a third fiber (heavy) fraction having a lower concentration of oil. The defibered mash lacking viscosity will cleanly separate in the second decanter tank 115 with the oil again rising to the top and the non-oil heavy material settling to the bottom. The top fraction is moved to a third decanter tank 116 and the bottom portion is moved to the secondary whole stillage tank 117. The third heavy fraction is transferred to the secondary whole stillage tank 117 with the first and second heavy fractions and the third light fraction undergoes further separation and/or is transferred downstream to undergo DCO recovery. The ratio of light to heavy material removed from the second decanter 115 can be adjusted to maximize oil separation as long as they are equal to the amount that is entering the tank. Since the second light fraction contains a higher percentage of oil than the first light fraction, a larger amount of light fraction and lesser amount of heavy fraction can be removed from the second decanter 115 compared to the ratio of materials removed from the first decanter 114.

In the embodiment shown in FIG. 2, the third light fraction is transferred to a third decanter 116 where a similar separation occurs resulting in a fourth liquid (light) fraction having a higher concentration of oil and a fourth fiber (heavy) fraction having a lower oil concentration. The third liquid phase entering the third decanter 116 is primarily a liquid phase (water and oil) that is mostly free of solids/fiber. In some embodiments caustic is added to the third light fraction in the third decanter to raise the pH of the material. In some embodiments, the pH is raised to about between 6.1 and 7.2, 6.3 and 6.9, or 6.6 and 6.8. In some embodiments the pH is raised to about 6.7. This helps break the emulsion of the any remaining liquid components to free the oil. Once again, the light oil fraction will rise to the top of the third decanter tank 116 and any remaining solids will settle to the bottom of the third decanter tank 116. The fourth heavy fraction is transferred to the secondary whole stillage tank 117 with the first, second, and third heavy fractions and the fourth light fraction undergoes further separation and/or is transferred downstream to undergo DCO recovery. The heavy fractions in the whole stillage tank 117 are sometimes referred to herein as a combined heavy fraction.

Some embodiments do not use all three decanter tanks 114, 115, 116. For example, in one embodiment the third decanter tank 116 is not used. Instead, the third heavy fraction (from the second decanter tank 115) is transferred to the secondary whole stillage tank 117 with the first and second heavy fractions and the third light fraction (from the second decanter tank 115) is transferred downstream to undergo DCO recovery. For example, the third light fraction may be transferred directly from the second decanter tank 115 to the DCO hold tank 104.

In some embodiments additional processes are used to increase the speed of the separation in one or more of the decanters 114, 115, 116, which results in the ability to use smaller tanks with less capital costs. These additional processes may include plate separators, enzymes, or chemical de-emulsifiers.

Each of the heavy fractions discussed herein contains fiber, water, protein, oil, and residual sugars. Each of the light fractions contain fiber, water, protein, oil, and residual sugars. Each successive separation (from the screw press 113 and the one or more decanters 114, 115, 116) results in a light fraction containing a higher percentage of oil and lower percentage of fibrous materials while each successive separation results in a heavy fraction containing a lower percentage of oil and a higher percentage of fibrous materials. In other words, after each separation the light/liquid stream becomes more oil-rich.

With continued reference to FIG. 2, the one or more heavy fractions in the secondary whole stillage tank 117 are directed to a mechanical separator such as a decanter centrifuge 101 to separate the thin stillage from the cake 109 (dewater the fibrous material). Thus, the decanter centrifuge 101 provides the same separation as in the exemplary traditional process shown in FIG. 1, except the fibrous material has a much lower concentration of oil in the embodiment shown in FIG. 2 since oil has been separated from the fibrous material in the screw press 113 and the one or more decanters 114, 115, 116. In some embodiments the secondary whole stillage tank 117 is kept with a constant gentle agitation. The heavy fraction from the decanter centrifuge 101 is the cake 109, which is directed to the dryers 110 for the recovering of DDGS 111. The liquid stream is a low-oil content thin stillage 102 which gets evaporated then directed to the DCO hold tank 104.

The thin stillage 102 is directed to the DCO hold tank where it is mixed with one or more of the oil-rich liquid phases. As used herein, “oil-rich” means having a higher percentage of light (oil and water) fraction than heavies (fiber) fraction. As explained above, the oil-rich stream separated from the fibrous material in the one or more decanters 114, 115, 116 is transferred to the DCO holding tank 104 where it is combined with the evaporated syrup from the thin stillage 102 stream. According to the concentrated oil effect, the oil globules will combine with each other in the DCO hold tank 104 with larger globules consuming smaller globules. This will concentrate the remaining oil in the hold tank 104. From the DCO holding tank 104 the oil-rich stream undergoes another separation, which may be by centrifuge 105, to separate the crude DCO from the defatted syrup 107 and recover the purified DCO 106. The defatted syrup 107 can be further processed and recovered as described above with respect to FIG. 1.

The process of removing the oil from the fibrous material of the whole stillage 100 then reintroducing the oil to the oil recovered from the thin stillage 102 provides significant benefits. Separating the oil-containing light fraction(s) from the fibrous material in several different steps (such as the screw press 113 followed by successive decanters 114, 115, 116) increases the amount of oil recovery. At each separation step the light fractions serve to wash the fibrous material of more oil through the law of solution since oil will bind itself in a ratio with the water in a mixture. When the water is separated from the mixture the ratio of oil to water will be the same in the light fraction as in the fraction that is trapped in the solids. The liquid will be removed with a certain ratio of oil to water. The liquid will be returned to the fibers where it will mix with the wet material and the oil to water ratio will be reset at a lower level. The fibrous fractions are then sent through a standard decanter centrifuge 101 as explained above. The decanter centrifuge 101 separation will again remove the water and the water remaining in the fibrous material will be at a lower oil content that a similar material that was not subjected to the successive separations.

As generally described above, FIG. 2 shows an embodiment wherein the one or more decanters 114, 115, 116 help separate the light fractions into oil, water, and solids phases in a series of tanks. The decanters 114, 115, 116 help concentrate the oil since each successive light fraction has more oil and less water and solids. Each heavy fraction contains fiber, protein, water, oil, and residual sugars. Each light fraction contains fiber, protein, water, oil, and residual sugars. Each successive separation results in a light fraction containing a higher percentage of oil and lower percentage of fiber and the heavy fraction containing a lower percentage of oil and higher percentage of fiber. In other words, after each separation the liquid stream becomes more oil-rich. In addition to phase separation, the time in decanting tanks 114, 115, 116 allows for the cohesion of oil globules which increases the efficiency of the separation. In one embodiment, the decanter tanks 114, 115, 116 are continuous flow decanters where a stream of material is continually entering each tank 114, 115, 116 and two streams of material are leaving each tank 114, 115, 116. In one embodiment the flow rate into each tank 114, 115, 116 may be about 400 gpm. The flow rate of each stream leaving the tank may be adjusted. In one embodiment the system may pull 100 gallons per minute (gpm) out of the top for the subsequent light fraction and 300 gpm out of the bottom for the subsequent heavy fraction. In other embodiments the total flow rate (in and out) may be adjusted as well as the relative light to heavy fraction flow rates leaving the respective decanter tanks 114, 115, 116.

The oil in the first tank 114 is held for several hours with the top fraction (oil) of the tank allowed to overflow to a second tank 115 and the bottom (fibrous) fraction removed by a pump and transferred to the secondary whole stillage tank 117. The average residence time in each tank 114, 115, 116 is between about 4-8 hours, and more particularly about 6 hours. With the continuous nature of the system, however, individual molecules may have more or less residence time. In some embodiments the bottom fraction may be split wherein a portion of the bottom fraction is recycled back to the screw press 113 and the remaining bottom fraction directed to the secondary whole stillage tank 117.

In some embodiments, the light fraction (oil and water mixture) in the second tank 115 is allowed to stand with the top fraction again allowed to overflow to the third tank 116 and the bottom fraction again returned to the secondary whole stillage tank 117.

In yet other embodiments, the light fraction (oil and water mixture) in a third tank 116 is allowed to stand with the top fraction (oil) again allowed to overflow and sent on to the oil hold tank 104 before the oil decanters and the bottom layer pumped to the secondary whole stillage tank 117.

In some embodiments, one of the decanter tanks 114, 115, 116 is configured to adjust the pH to about 6.7 using waste caustic from the clean-in-place (CIP) system. In some embodiments the pH is adjusted in the third 116 or last tank before downstream DCO recovery. In these embodiments, the protein oil emulsion is broken up by the lower pH to further separate the oil fraction. In other embodiments the pH is adjusted to 6.3, 6.4, 6.5, 6.6, 6.8, 6.9, 7.0 or 7.1. The top oil layer is either run through a stack disc centrifuge and the oil fraction is piped beyond the evaporation system and returned to the oil hold tank or the top oil fraction is returned beyond the evaporation system and directly into the hold tank in some embodiments. The evaporation may comprise at least one, two, or three evaporators. The bottom fibrous fraction is removed and returned to the secondary whole stillage tank 117 in these embodiments.

In some embodiments, the defatted liquid returned to the secondary whole stillage tank 117 which is critical to the high oil separation. In these embodiments, this liquid will mix with the heavy fractions and pick up the oil in the cake. A new equilibrium will be achieved between the oil that is trapped in the cake and the oil that is captured in the light fraction as in some embodiments. Further, the cleaner the oil is that returns to the cake the more it will pick up. In some embodiments, pure water is used. The addition of new water to the system could upset the delicate water balance in this portion of the plant.

In some embodiments, the cake when sent on to the decanter will be separated into a cake and thin stillage. In these embodiments, this stillage will contain less oil than “normal” thin stillage as some was already removed but then so will the cake. Because the oil in the cake is lost oil in known processes, the present process will produce more oil than the standard system as in some embodiments.

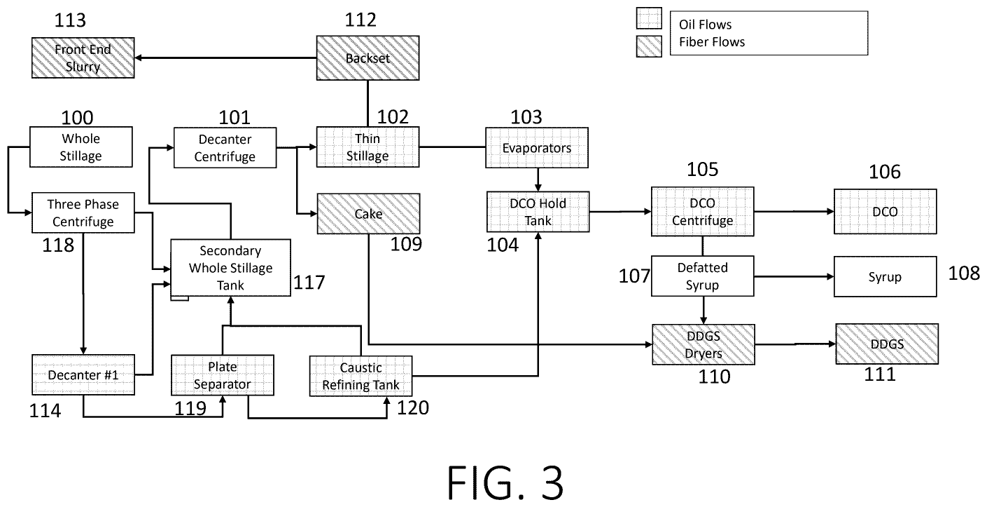

In some embodiments, the separation process using the natural properties of decanting does not require additional power which minimizes the greenhouse gas impact of the process. Another embodiment is shown in FIG. 3 wherein the whole stillage 100 is introduced to a three-phase centrifuge 118 which separates the whole stillage 100 material into an oil fraction, a water fraction and a solid fraction. The water fraction and the oil fraction (together the first light fraction) are directed to a settling tank, such as decanter 114. The solid (first heavy fraction) is directed to the secondary whole stillage tank 117. The first decanter 114 separates the first light fraction into a second fibrous/heavy fraction which is transferred to the secondary whole stillage tank 117 and a second liquid/light fraction which is transferred to a plate separator 119. The second light fraction has a high concentration of oil than the first light fraction. The plate separator 119 separates the second light fraction into a third fibrous/heavy fraction which is directed to the secondary whole stillage tank 117 and a third liquid/light fraction which is transferred to a caustic refining tank 120 to further concentrate oil.

The plate separator 119 helps increase the globular size of each oil droplet, which helps improve downstream centrifugation. The oil has been through several separations by the time it reaches the caustic refining tank 120. The water/oil emulsion uses residual protein to hold these two materials together. The caustic refining tank 120 helps free the oil from the water by increasing pH to about between 6.5-6.9 so the protein drops out of solution as it is at its iso-electric point. Changing the pH of fibrous material is more difficult than changing the pH of liquid materials. Thus, it is beneficial to have the stream contain as little fiber as possible when it enters the caustic refining tank 120.

The material in the caustic refining tank 120 is fractionated with the lower/heavy fraction flowing to the secondary tank 117 and the upper/light fraction moving to the DCO hold tank 104. The secondary tank 117 now contains heavy fractions from the three-phase centrifuge 118, the first decanter tank 114, the plate separator 119, and the caustic refining tank 120. The combined heavy fractions in the secondary tank 117 are introduced to the decanter centrifuge 101. The centrifuge 101 further separates the heavy fractions into a fibrous/heavy fraction and a liquid/light fraction, the light fraction being the thin stillage 102 and the solid portion being the cake 109. The oil-rich fraction of the thin stillage 102 is transferred to the evaporators 103. From the evaporators 103, the resulting material moves to the DCO hold tank 105, which also holds material from the caustic refining tank 120. From the DCO holding tank 104 the oil-rich stream undergoes another separation, which may be by centrifuge 105, to separate the crude DCO from the defatted syrup 107 and recover the purified DCO 106. The defatted syrup 107 can be further processed and recovered as described above with respect to FIG. 1.

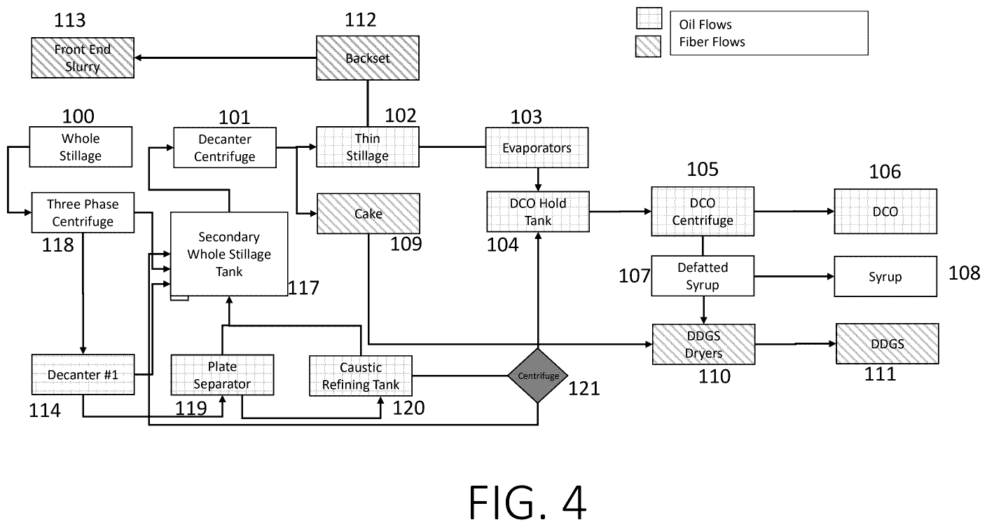

FIG. 4 shows another embodiment similar to the embodiment shown in FIG. 3. The embodiment shown in FIG. 4 includes an additional separation step. As shown in FIG. 4, a centrifuge 121 (this centrifuge is optional because it may be nearly pure oil at this point) receives the upper oil-containing liquid stream from the caustic refining tank 120. The centrifuge 121 further separates the oil-rich stream into a fiber/heavy fraction which is transferred to the secondary whole stillage tank 117 and a liquid/light fraction which is transferred to the DCO hold tank 104. The use of the centrifuge 121 further separates fiber from oil and increases the percentage of oil and DCO 106 output.

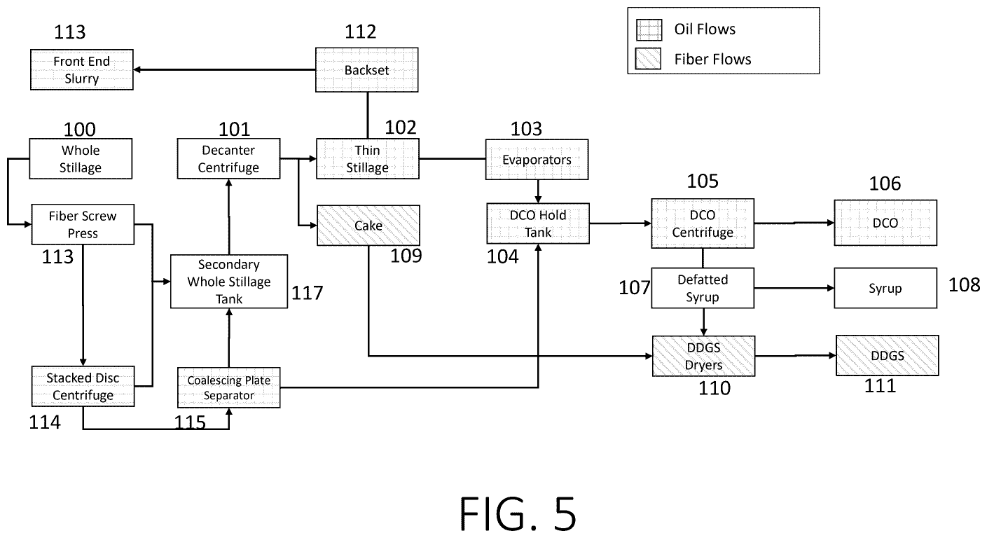

FIG. 5 shows another embodiment similar to the embodiment shown in FIG. 3. In this his embodiment the whole stillage 100 is introduced to a fiber screw press 113. This press 113 uses mechanical pressure to separate the solid material from the liquid material in the mash. The solid material is sent to the secondary whole stillage tank 117 and the liquid material is sent to a centrifuge 114 for further separation.

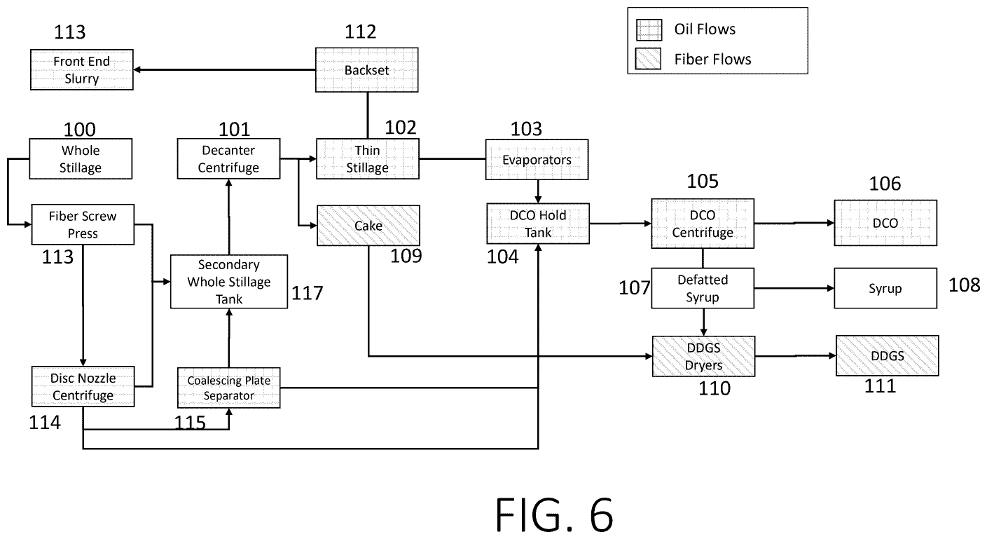

The centrifuge 114 can be a stacked disc centrifuge (FIG. 5), decanter centrifuge, or a disc nozzle (three phase) centrifuge (FIG. 6). This centrifuge 114 uses the differences in density to separate the lighter oil rich fractions from the heavier water fraction in the liquids. In experiments on this process as much as 95% of the oils in the light fraction can be removed by centrifugation. The oil rich fraction is sent directly to the DCO hold tank 104. The heavier water rich fraction is sent to the secondary hold tank 117.

As shown in FIGS. 5 and 6, the water rich fraction from the centrifuge is directed to a coalescing plate separator 115. This is a mechanical process that forces very small oil globules together in a way they can be removed from the liquids. These globules are so small that they cannot be separated through the centrifuge. This light/oil fraction is sent to the DCO hold tank 104 and the heavy/water fraction is directed to the secondary whole stillage tank 117.

In some embodiments of the invention there is enhanced efficiency relative to traditional oil separation processes. In some embodiments, the screw press efficiently separates fiber from whole stillage, which allows the oil to be separated from the fiber before the cake is subjected to the decanter centrifuge. This allows the oil that was going to be lost in the centrifuge cake to be recovered. This allows substantially higher yields of oil to be extracted from the mash.

In some embodiments, the separation of oil before evaporation will decrease the fouling of the evaporators 103 and increase the uptime of the facility. In some embodiments the decrease in fouling will be 1.5, 2.0, 2.5, 3.0, 3.5, 4.0, 4.5, 5.0, 5.5, 6.0, or 7.0 times less than with traditional processes.

In some embodiments oil is recovered at a rate greater than 1 pound per bushel. In some embodiments oil is recovered at a rate of greater than 1.5 pounds per bushel.

In some embodiment, the method results in recovery of purified DCO from the DCO hold tank 104 in an amount greater than 1.0, 1.25, 1.5, 1.75 or 2 pounds per bushel.

In some embodiments, the system results in about a 4% reduction in energy load to the ethanol production plant. Additionally, there is about a 4% reduction in the volume of material. The invention of the disclosure decreases non-fermentable solids, resulting in a more efficient fermentation. In some embodiments, the backset solids are less than about 4%, reducing grain inputs and increasing fermentation efficiency. In some embodiments, this results in higher throughput (between about 10-50%) and improved yield (between about 5-20%).

In other embodiments the system results in lower solids in the backset, increasing throughput and improving fermentation efficiency.

### EXAMPLES

Embodiments of the invention were modeled in a research lab. The whole stillage samples were obtained from three different ethanol producers. The material ranges from about 12% solids to about 15% solids and contains oil content of about 9.35% d.b. to about 15.93% d.b.

| Whole | Sample | Total | Oil Content | Total Oil |
|---|---|---|---|---|
| Stillage | Mass (kg) | Solids (%) | (%)\textcircled{¹} | (kg)\textcircled{²} |
| Min | 601 | 12.63 | 9.35 | 8.54 |
| Max | 1435 | 15.23 | 15.93 | 20.43 |
| Mean | 978 | 13.45 | 12.91 | 15.68 |

^{\textcircled{1}}Oil Content as a percentage of the solids
^{\textcircled{2}}Total Oil = Total Mass * Total Solids *Oil Content

The total oil content of each sample was calculated as Mass*Solids*Oil Content to determine the absolute amount of oil in the sample. This calculation was used throughout the research to determine the absolute path of the oil through the process.

The material was separated into a liquid fraction and a solids fraction at the first step using various mechanical separation devices. Each fraction was analyzed to determine how to maximize the separation of the solids and liquids but also which device forces the most oil into the liquid fraction. The three mechanical devices used in this exemplary process were a screw press, a decanter centrifuge, and a stacked disc centrifuge.

The stacked disc showed early promise but the solids content in the whole stillage quickly fouled the machine, and this device was dropped from the study.

The decanter centrifuge and the screw press both resulted in good separation of the liquid and the solids fractions. The decanter centrifuge yielded a cleaner separation with little, or no solids being passed into the liquid fraction. The screw press yields a more complete liquid solid separation even though it pushed some small fraction of solids into the liquids. The screw press also expressed a higher fraction of oil into the liquid fraction.

| | | | Oil | Oil | |
|---|---|---|---|---|---|
| Liquid | Sample | Total | Content | Separation | Total Oil |
| Fraction | Mass (kg) | Solids (%) | (%) | (%)\textcircled{¹} | (kg) |
| Decanter | 751.50 | 10.04 | 17.50 | 65% | 13.20 |
| Mean | | | | | |
| Screw Press | 837.00 | 10.64 | 16.33 | 80% | 12.87 |
| Mean | | | | | |

^{\textcircled{1}}Oil Separation = Total Oil after separation/before separation

The mass percentage represents the percentage of the total incoming mass that ended up in the liquid fraction. The oil separation percentage was the amount of incoming oil that was found in the liquid fraction. In the trials run, more of the oil was expressed in the liquid with the use of a screw press than with the use of the decanter centrifuge.

The cake portion has very low oil and in the process would be returned to a secondary tank where it is eventually washed with the defatted liquid from the liquid stream. The cake portion is made up as follows:

| | | | Oil | Oil | |
|---|---|---|---|---|---|
| | Sample | Total | Content | Separation | Total Oil |
| Cake | Mass (kg) | Solids (%) | (%) | (%)\textcircled{¹} | (kg) |
| Decanter | 251.00 | 29.19 | 4.05 | 17.5% | 2.97 |
| Mean | | | | | |
| Screw Press | 56.70 | 46.00 | 4.11 | 9.4% | 0.94 |
| Mean | | | | | |

^{\textcircled{1}}Oil Separation = Total Oil after separation/before separation

The next trials that were run involved removing the oil from the liquid stream. This was done with a decanter centrifuge and with a stacked disc centrifuge. The stack disc can exert more g-force to the solution and so, as expected, was able to separate more of the oil from the liquids. The trials that were run saw the stacked disc centrifuge remove 96% of the oil from the liquid fraction. Although no attempt was made to make this stream a pure oil stream is was a very concentrated cream layer. In the process this cream layer made up of large globule sized oil fragments would be returned to the corn oil hold tank located after the evaporators and serve as a natural de-emulsifier on the oil being readied for the Corn oil separators.

Some exemplary experiments have shown the processes described herein are able to recover almost twice as much DCO 106 compared with traditional processes. For example, some experiments have shown DCO 106 recovery averages about 1.5 pounds per bushel using embodiments of the invention comparted to only 0.9 pounds per bushel using existing methods.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

1. A process for recovering distillers corn oil (“DCO”) from whole stillage comprising:
introducing whole stillage to a mechanical separation device for separating the whole stillage into a first light fraction and a first heavy fraction;
directing the first heavy fraction to a whole stillage tank and directing the first light fraction to a first separator for separating the first light fraction into a second light fraction and a second heavy fraction;
directing the second heavy fraction to the whole stillage tank and directing the second light fraction to a second separator for separating the second light fraction into a third light fraction and a third heavy fraction;
directing the third heavy fraction to the whole stillage tank and directing the third light fraction to a DCO hold tank;
wherein the first, second, and third heavy fractions in the whole stillage tank comprise a combined heavy fraction;
directing the combined heavy fraction to a mechanical separator unit for separating the combined heavy fraction into a thin stillage and a cake, then directing the thin stillage to the DCO hold tank;
wherein the DCO hold tank comprises a crude DCO;
separating the crude DCO into a defatted syrup and a purified DCO; and
recovering the purified DCO.

2. The process of claim 1 wherein the mechanical separation device is one of a fiber screw press or a three phase centrifuge.

3. The process of claim 1 wherein the first separator and the second separator are decanters.

4. The process of claim 1 wherein the first separator is a centrifuge and the second separator is a plate separator.

5. A process for recovering distillers corn oil (“DCO”) from whole stillage comprising:
introducing whole stillage to a mechanical separation device for separating the whole stillage into a first light fraction and a first heavy fraction;
directing the first heavy fraction to a whole stillage tank and directing the first light fraction to a first decanter for separating the first light fraction into a second light fraction and a second heavy fraction;
directing the second heavy fraction to the whole stillage tank and directing the second light fraction to a second decanter for separating the second light fraction into a third light fraction and a third heavy fraction;
directing the third heavy fraction to the whole stillage tank and directing the third light fraction to a DCO hold tank;
wherein the heavy fractions in the whole stillage tank comprise a combined heavy fraction;
directing the combined heavy fraction to a mechanical separator unit for separating the combined heavy fraction into a thin stillage and a cake, then directing the thin stillage to the DCO hold tank;
wherein the DCO hold tank comprises a crude DCO;
separating the crude DCO into a defatted syrup and a purified DCO; and
recovering the purified DCO.

6. The process of claim 5 wherein the mechanical separation device is a screw press, a filter press, a tricanter, a stack disc centrifuge, or a three phase centrifuge.

7. The process of claim 5 wherein the first decanter and the second decanter are continuous flow decanters where a stream of crude material is continually entering each decanter and two streams of separated material are continually leaving each decanter.

8. The process of claim 5 further comprising directing the thin stillage to an evaporator for concentrating the oil-rich thin stillage before directing the thin stillage to the DCO hold tank.

9. The process of claim 5 further comprising directing the cake to dryers, then recovering distillers dry grain with solubles (“DDGS”).

10. The process of claim 5 further comprising recovering the defatted syrup.

11. The system of claim 5 wherein the purified DCO recovered is greater than 1.25 pounds per bushel of whole stillage.

12. The system of claim 5 wherein the purified DCO recovered is greater than 1.5 pounds per bushel of whole stillage.

13. The process of claim 5 wherein the mechanical separator unit is a centrifuge or a settling tank.

14. The process of claim 5 wherein the third light fraction is directed to a third decanter instead of the DCO hold tank for separating the third light fraction into a fourth light fraction and a fourth heavy fraction, wherein the fourth heavy fraction is directed to the secondary whole stillage tank and the fourth light fraction is directed to the DCO hold tank.

15. A process for recovering distillers corn oil (“DCO”) from whole stillage comprising:
introducing whole stillage to a three phase centrifuge for separating the whole stillage into a first light fraction and a first heavy fraction;
directing the first heavy fraction to a whole stillage tank and directing the first light fraction to a first decanter for separating the first light fraction into a second light fraction having oil droplets and a second heavy fraction;
directing the second heavy fraction to the whole stillage tank and directing the second light fraction to a plate separator for increasing the globular size of each oil droplet and separating the second light fraction into a third light fraction and a third heavy fraction;
directing the third heavy fraction to the whole stillage tank and directing the third light fraction to a caustic refining tank for increasing the pH and separating the third light fraction into a fourth light fraction and a fourth heavy fraction;
directing the fourth heavy fraction to the whole stillage tank and directing the fourth light fraction to a DCO hold tank;
wherein the first, second, third, and fourth heavy fractions in the whole stillage tank comprise a combined heavy fraction;
directing the combined heavy fraction to a mechanical separator unit for separating the combined heavy fraction into a thin stillage and a cake, then directing the thin stillage to the DCO hold tank;
wherein the DCO hold tank comprises a crude DCO;
separating the crude DCO into a defatted syrup and a purified DCO; and
recovering the purified DCO.

16. The process of claim 15 wherein the caustic refining tank increases pH to between about 6.5-6.9 to help separate protein from the third light fraction.

17. The process of claim 15 wherein the fourth light fraction is directed to a centrifuge instead of the DCO hold tank for separation into a fifth light fraction and a fifth heavy fraction, then transferring the fifth heavy fraction to the whole stillage tank and transferring the fifth light fraction to the DCO hold tank.

18. A process for recovering distillers corn oil (“DCO”) from whole stillage comprising:
introducing whole stillage to a screw press for separating the whole stillage into a first light fraction and a first heavy fraction;
directing the first heavy fraction to a whole stillage tank and directing the first light fraction to a first centrifuge for separating the first light fraction into a second light fraction having oil droplets and a second heavy fraction;
directing the second heavy fraction to the whole stillage tank and directing the second light fraction to a plate separator for increasing the globular size of each oil droplet and separating the second light fraction into a third light fraction and a third heavy fraction;
directing the third heavy fraction to the whole stillage tank and directing the third light fraction to a DCO hold tank;
wherein the first, second, and third heavy fractions in the whole stillage tank comprise a combined heavy fraction;
directing the combined heavy fraction to a mechanical separator unit for separating the combined heavy fraction into a thin stillage and a cake, then directing the thin stillage to the DCO hold tank;
wherein the DCO hold tank comprises a crude DCO;
separating the crude DCO into a defatted syrup and a purified DCO; and
recovering the purified DCO.

19. The process of claim 18 wherein the first decanter, the second decanter, and the third decanter are all continuous flow decanters where a stream of crude material is continually entering each decanter tank and two streams of separated material are continually leaving each decanter tank.

20. The process of claim 18 further comprising directing the thin stillage to an evaporator for concentrating the oil-rich thin stillage before directing the thin stillage to the DCO hold tank.

21. The process of claim 18 wherein the first centrifuge is a stacked disc centrifuge or a disc nozzle three-phase centrifuge.
